(19) United States
(12) Patent Application Publication
(10) Pub. No.: US 2025/0060316 A1
(43) Pub. Date: Feb. 20, 2025

(54) APPARATUS FOR ACQUIRING THREE-DIMENSIONAL INFORMATION OF OBJECTS AND SURFACES FOR AN ARTIFICIAL VISION SYSTEM FOR AUTOMATIC OPTICAL INSPECTION OF THE VISUAL QUALITY OF AN UNDERLYING OBJECT, IN PARTICULAR ELECTRONIC ASSEMBLIES, CIRCUIT BOARDS AND THE LIKE

(71) Applicant: SCUOLA UNIVERSITARIA PROFESSIONALE DELLA SVIZZERA ITALIANA (SUPSI), Manno (Lugano) (CH)

(72) Inventors: Daniele Guido ALLEGRI, Claro (CH); Andrea GALLI, Ponte Capriasca (CH); Roberto GARDENGHI, Motto (CH)

(73) Assignee: SCUOLA UNIVERSITARIA PROFESSIONALE DELLA SVIZZERA ITALIANA (SUPSI), Manno (Lugano) (CH)

(21) Appl. No.: 18/721,162

(22) PCT Filed: Dec. 20, 2022
(86) PCT No.: PCT/EP2022/086872

§ 371 Date: Jun. 17, 2024

(30) Foreign Application Priority Data
Dec. 20, 2021 (CH) 070752/2021
Dec. 20, 2021 (IT) 102021000031832

(51) Int. Cl. G01N 21/88; G01N 21/956

(52) U.S. Cl. CPC G01N 21/8806; G01N 21/8851; G01N 21/956; G01N 2021/8816; G01N 2021/8848; G01N 2021/8887

(57) ABSTRACT

An apparatus for acquiring three-dimensional information of objects and surfaces comprising a first camera having a vertical optical axis, a first flat sensor having orthogonal axes lying in a horizontal plane, a second camera having a horizontal optical axis, a second flat sensor having orthogonal axes lying in a vertical plane, a plurality of light projectors angularly spaced around the vertical optical axis of the first camera, a first vertical optical arm associated with the first camera and coaxial with the vertical optical axis, a second horizontal optical arm associated with the second camera and coaxial with the horizontal optical axis, an optical beam splitter splitting the light beam reflected by the object into first and second light beams directed along the first and second optical arms, wherein the first and second flat sensors have the same shape and arranged to acquire the object with the same field of view.

### CROSS-REFERENCE TO RELATED APPLICATIONS

The present application is a U.S. National Phase Application under 35 U.S.C. § 371 of International PCT/EP2022/086872 filed Dec. 20, 2022, which claims priority of Italian Patent Application No. 102021000031832 filed Dec. 20, 2021, and Swiss Patent Application No. 070752/2021 filed Dec. 20, 2021. The entire contents of which are hereby incorporated by reference.

### FIELD OF THE INVENTION

The present invention refers to an apparatus for acquiring three-dimensional information of objects and surfaces for an artificial vision system for automatic optical inspection of objects, in particular, but not limited to, electronic assemblies, electronic boards and the like.

### BACKGROUND

It is known that artificial vision systems for visual quality inspection are widely applied in manufacturing industry with high production volumes, in the semiconductor industry, in food and pharmaceutical industry and are based on standard image processing and artificial vision techniques such as, but not only, edge detection, analysis of connected components, plot analysis and projective geometry.

These approaches are simple and very effective when performing quantitative measurements of well-defined entities (such as lengths, widths, colors, fine-grained patterns) is required; once the measurements are completed, simple tools based on pre-established rules can be used to assess whether or not an observed product meets the acceptance criteria.

In particular, in this field, the expression “Automatic Optical Inspection” (AOI) generally refers to an automated visual inspection system of the quality of objects (which may consist of electronic assemblies, such as printed circuit boards, i.e. PCBs and Surface Mount Technology, i.e. SMT) in which a camera independently scans the object under test.

In particular, in the case of electronic assemblies, the camera makes it possible to identify both manufacturing defects (e.g. missing components) and quality defects (e.g. size or shape of the fitting or inclination of the component). AOIs are commonly used in production processes because they are non-contact test and inspection methods; AOIs are implemented in many phases of the production process, including bare panel inspection, solder paste inspection (SPI), pre-and post-die casting, and other phases.

As is known, all automatic optical inspection systems substantially require a light, or one or more luminous wefts, to be projected onto the object to be inspected and to acquire the light reflected by the object via a digital sensor; the acquired images are analysed by a processing unit configured to determine the physical and/or geometric characteristics of the object to be inspected based on the light acquired by the sensor.

Nowadays, in the field of automated quality visual inspection systems for electronic assemblies, there is an increasing need to acquire coordinated measurements on line.

Since the complexity of today's electronic boards is constantly increasing (due to the use of multiple components, multiple joints, the presence of a higher density of components and the use of new packaging technologies such as microchips of size 01005 and even of size 008004), the two-dimensional automatic optical inspection technology that uses the analysis of greyscale images or the analysis of color images obtained from side cameras may no longer be a valid option.

To overcome these limitations, three-dimensional scanning technology has been effectively combined with AOI and is now used for many applications such as the inspection of microelectronic components and solder paste deposits below 100 microns and other challenging applications.

It is also known that, although functional, these known systems have limitations and have some disadvantages and limitations.

In particular, some limitations arise from the nature of the measurement technique, while others are more particularly related to the measurement of electronic assemblies (SMT and PCB) and comprise:
difficulty in ensuring full measurement of low components near high components due to the shadow effect (if the reference plot is projected angled, the high sections may cast a shadow, preventing the measurement of the neighboring low sections);
difficulties in avoiding measurement errors caused by multiple reflections between the components (multiple specular reflections between shiny elements, such as weld joints, tinned cables and metal oscillators, can cause distortions in the fringe pattern and errors in height measurements);
difficulties in ensuring fast, highly accurate and repeatable measurements in the micrometer (μm) field in all directions.

A further difficulty is given by the physical complexity and the overall dimensions of the components of the image acquisition systems of the known systems, which require relatively large dimensions for the complete inspection system and to ensure the non-interference of the different components.

There is therefore a need to improve the structure of the known artificial vision systems for inspection of the visual quality.

### SUMMARY

The technical task proposed by the present invention is, therefore, to realize an apparatus for acquiring three-dimensional information of objects and surfaces for an artificial vision system for automatic optical inspection of the visual quality of artefacts which allows the aforementioned technical drawbacks of the prior art to be eliminated.

As part of this technical task, an object of the invention is to realize an apparatus for acquiring three-dimensional information of objects and surfaces for an artificial vision system for automatic optical inspection of the visual quality that is simple and effective.

Another object of the invention is to realize an apparatus for acquiring three-dimensional information of objects and surfaces for an artificial vision system for automatic optical inspection of the visual quality that is compact in size.

Last but not least, the object of the invention is to realize an apparatus for acquiring three-dimensional information of objects and surfaces for an artificial vision system for automatic optical inspection of the visual quality that can guarantee fast, highly accurate and repeatable measurements.

The technical task, together with these and other objects according to the present invention, are attained by realizing an apparatus for acquiring three-dimensional information of objects and surfaces for an artificial vision system for automatic optical inspection of the visual quality of an underlying object, comprising a first camera having a vertical optical axis Z and a first flat sensor having orthogonal axes X, Y lying in a horizontal plane and a second camera having a horizontal optical axis X′ and a second flat sensor having orthogonal axes Y′, Z′ lying in a vertical plane, a system for illuminating the object from above comprising a plurality of light projectors, an optic of the first and of the second camera comprising a dual objective optical group having a first vertical optical arm associated with said first camera and coaxial with said vertical optical axis Z and a second horizontal optical arm associated with said second camera and coaxial with said horizontal optical axis X′, an optical beam splitter configured to split the light beam reflected by said object into a first light beam directed along said first optical arm and a second light beam directed along said optical second arm, wherein the light projectors are angularly spaced around the vertical optical axis Z of said first camera, and wherein said first and second flat sensors have the same shape and are arranged to acquire said object with the same field of view.

The light projectors may comprise structured or unstructured light sources.

The optical group preferably but not necessarily is a telecentric or bi-telecentric optical group.

In one embodiment, one of the first and second cameras is preferably a high-resolution camera.

In one embodiment, one of the first and second cameras is a camera capable of acquiring images containing information related to the polarisation of the light incident on the sensor.

In one embodiment, the light projectors are positioned with a vertical projection axis.

In one embodiment, the light projectors are positioned with an inclined projection axis.

In one embodiment, a plurality of mirrored reflectors is interposed between the plurality of light projectors and a station for the object for the conversion of the optical path of the light from the projectors to the object.

In one embodiment, a series of monochromatic or polychromatic light emitting rings coaxial with the vertical optical axis of the first camera having a decreasing diameter and a decreasing distance away from the first camera are included.

Other features of the present invention are further defined in the following claims.

### BRIEF DESCRIPTION OF THE DRAWINGS

Further characteristics and advantages of the invention will become more apparent from the description of a preferred, but not exclusive, embodiment of the apparatus according to the invention, which is illustrated by way of non-limiting example in the attached drawings, of which:

FIG. 1 shows an elevation schematic view of the apparatus in a first embodiment;

FIG. 2 shows a schematic plan view of the apparatus in a first embodiment;

FIG. 3 shows an elevation schematic view of the apparatus in a second embodiment; and

FIG. 4 shows a schematic plan view of the apparatus in a second embodiment.

### DETAILED-DESCRIPTION

The following detailed description refers to the appended drawings, which form a part thereof.

In the drawings, similar reference numbers typically identify similar components, unless the context indicates otherwise.

The embodiments described in the detailed description and in the drawings are not intended to be limiting.

There may be other embodiments, and other modifications can be made without departing from the spirit and scope of the subject matter in question represented herein.

The aspects of the present description, as generally described in the present context and illustrated in the figures, may be arranged, replaced, combined and designed in a wide range of different configurations, which are all contemplated explicitly and are part of this description.

With reference to the aforementioned figures, an apparatus for acquiring three-dimensional information of objects and surfaces for an artificial vision system for automatic optical inspection of the visual quality of an underlying object indicated overall with reference number 1 is shown.

The apparatus 1 comprises a first camera 10 typically positioned in an upper position having a vertical optical axis Z and a first flat sensor 110 having orthogonal axes X,Y lying in a horizontal plane.

The apparatus 1 further comprises a second camera 20 having a horizontal optical axis X′ and a second flat sensor 120 having orthogonal axes Y′, Z′ lying in a vertical plane.

The apparatus comprises a dual objective optical group 55, comprising one or more lenses and possibly other optical elements, which acts as an optic for both the first camera 10 and the second camera 20.

Preferably, said optical group 55 is telecentric or bi-telecentric, i.e. it forms a telecentric or bi-telecentric optic having the input pupil and/or the output pupil infinitely.

The optical group 55 comprises an optical beam splitter 50 (typically, but not limited to, a prism) configured to split the light beam reflected by the object 100 into a first light beam directed along a first vertical optical arm 51 associated with the first camera 10 and coaxial with the vertical optical axis Z of the first camera 10, and a second light beam directed along a second horizontal optical arm 52 associated with the second camera 20 and coaxial with the horizontal optical axis X′ of the second camera 20.

The optical arms 51, 52 to which reference is made are in practice optical paths, preferably linear, which can be defined by optical and structural elements of a known type.

Advantageously, the horizontal optical arm 52 of the optical group 55, and consequently the optical axis X′ of the second camera 20, is positioned with a first offset angle a. from an axis X of the first sensor of the first camera 10.

Advantageously, the dual objective optical group 55 is able to support two cameras with the same or even different sizes of the sensors and thus allow to measure objects with different magnification factors for each camera and also to support two different magnification factors.

The first flat sensor 110 and the second flat sensor 120 are two-dimensional pixel sensors, for example but not necessarily CMOS or CCD sensors.

Advantageously and typically, the first camera 10 is a high-resolution camera, with a resolution preferably of at least 12 Megapixels that allows high resolution 3D data to be obtained.

Advantageously, the second camera 20 is a camera capable of acquiring images containing information related to the polarisation of the light incident on the sensor, typically but not necessarily a camera with integrated polarisation sensor, which allows to acquire images without reflections, or with strongly reduced reflections and glares on reflective surfaces such as, for example, but not limited to, plastic and metal.

With the images obtained from the second camera it is possible to reconstruct the shape, and therefore 3D information, of those parts of components of reflective material (mainly metal, such as welds) that cannot be reconstructed effectively with structured light projection techniques, precisely because they are reflective materials.

The apparatus 1 comprises a system for illuminating the object 100 to be inspected from above, typically placed in a lower position, comprising a plurality of light projectors 30i, typically four light projectors preferably configured to emit structured light, such as DLP (Digital Light Processing) projectors or other projectors capable of emitting structured light fringes, even more preferably to emit sinusoidal or binary patterns (fringe images) adapted to realize a profilometry of the type known as phase-shift profilometry (PSP).

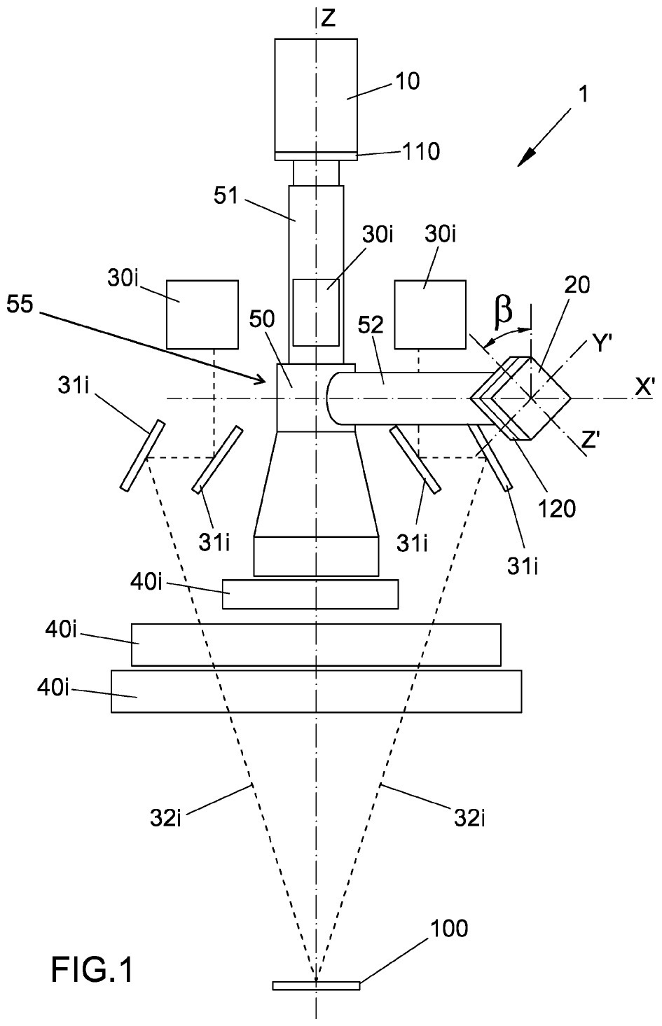

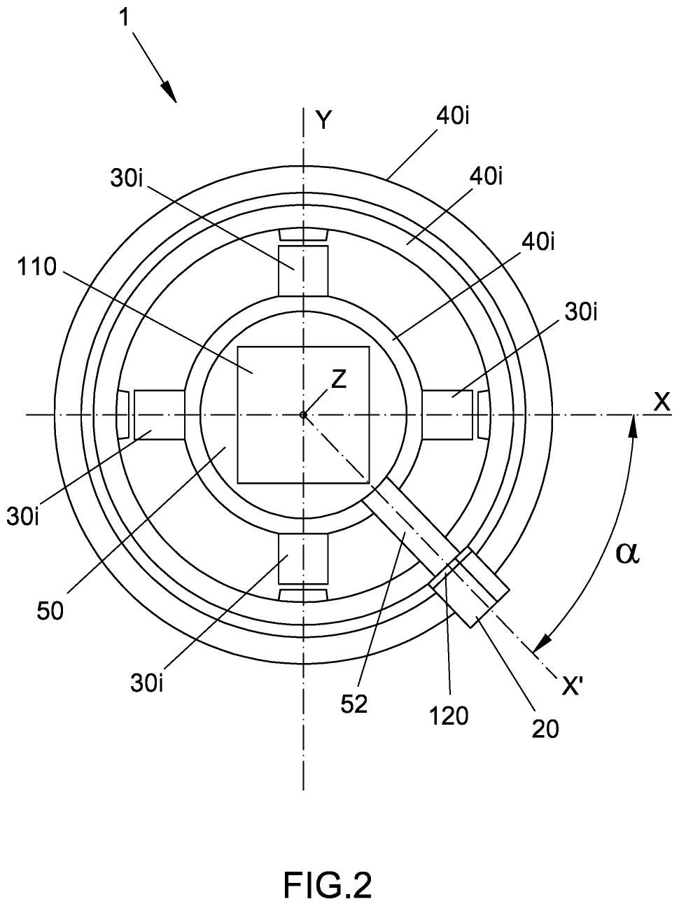

In a first embodiment, illustrated in FIGS. 1 and 2, the light projectors 30i preferably have the vertical projection axis parallel to the vertical optical axis Z of the first camera 10, and the illumination system comprises a plurality of mirrored reflectors 31i reciprocally interposed between the plurality of projectors 30i and the station for the object 100 for the conversion of the plurality of optical paths 32i of the light from the plurality of projectors 30i to the object 100.

The single light projectors 30i and the corresponding mirrored reflectors 31i are equally angularly spaced around the vertical optical axis Z of the first camera 10.

Typically, at least one light projector 30i is placed, relative to the vertical optical axis Z of the first camera 10, in an angular position coinciding with that of the axis X of the first sensor 110 of the first camera 10.

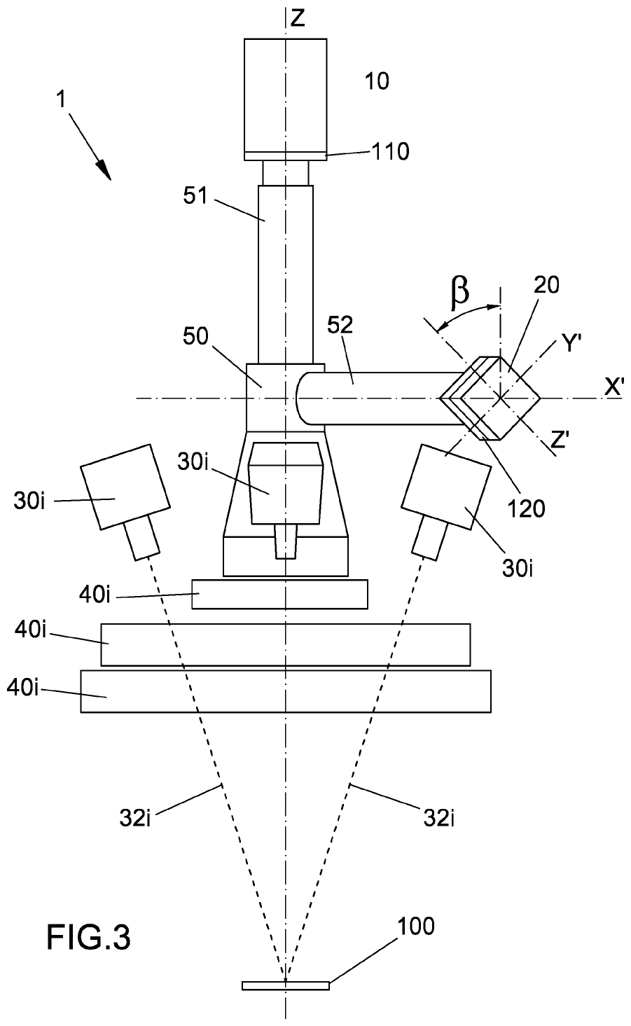

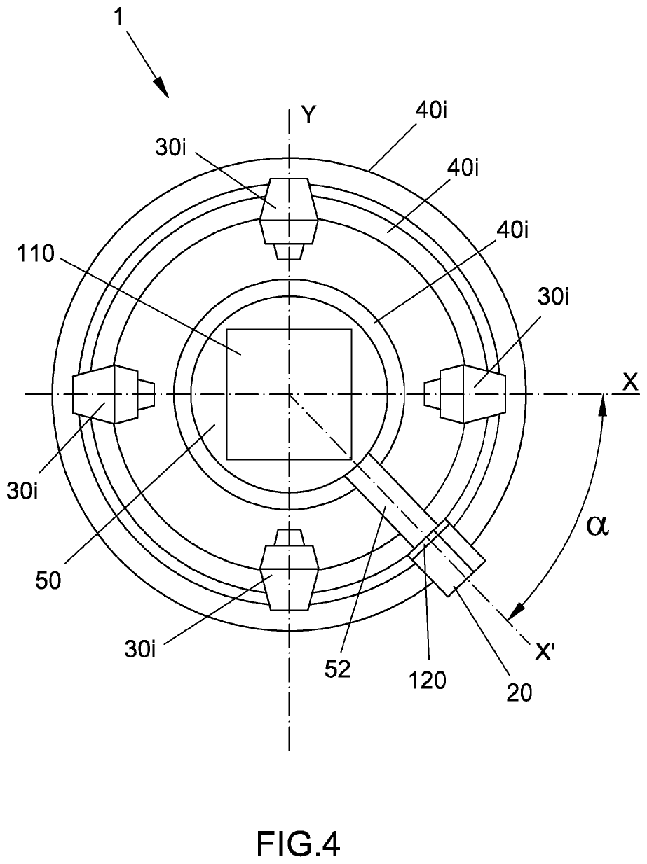

In a second embodiment, illustrated in FIGS. 3 and 4, the light projectors 30i have projection axes inclined relative to the vertical axis Z and arranged so as to converge on the station for the object 100.

Also in the second embodiment, the single light projectors 30i are equally angularly spaced around the vertical optical axis Z of the first camera 10.

By way of non-limiting example, each light projector 30i may comprise at least one LED light source, at least one lens, an optical beam splitter, and a digital micromirror display (DMD) device, wherein a lens can be positioned between the LED light source and the optical beam splitter, the optical beam splitter can be positioned between the lens and the digital micromirror display (DMD) device, and a further lens (or a system of lenses) may be positioned between the DMD and the object to be illuminated.

Typically, in a preferred solution, each light projector 30i comprises at least three different monochrome LED light sources, each associated with a corresponding lens, and an optical system interposed between the lenses and the optical beam splitter is configured to collimate the light beams emitted by the three LED light sources.

The apparatus 1 may further comprise a system for the direct illumination of the object 100. Such an indirect illumination system preferably comprises a plurality of monochromatic or polychromatic light emitting rings 40i, or a plurality of light emitting rings arranged along a plurality of rings, which rings are coaxial with the vertical optical axis Z of the first camera 10 having an increasing diameter and an increasing distance away from the first camera 10.

Advantageously, moreover, an axis Z′ of the second sensor of the second camera 20 is oriented with a second offset angle β relative to a vertical axis parallel to the vertical optical axis Z, uniquely determined by the value of the first offset angle α.

The offset of an angle β relative to the vertical axis corrects the rotation of the projection caused by the first offset angle α.

In particular, β=α+90° with α≠0 can be set.

Therefore, if the first and second sensors have the same shape, and the optical system 55 is suitably sized such that the image transmitted to the camera 10 and the image transmitted to the camera 20 turn out to have the correct magnification so as to collimate the field of view 100 to the sensors in an accurate manner, according to the present invention it is possible to acquire the object 100 with the same field of view by the first camera 10 and by the second camera 20.

Suitably, the light projectors 30i and cameras (10 and 20) are operatively connected to an electronic control unit (not illustrated) that commands and controls the actuation, i.e. the activation of the light projectors 30i, the cameras (10 and 20) and possibly also the system for the indirect illumination of the object 100.

According to an optimal solution, the electronic control unit is configured to actuate i.e. activate the light projectors 30i alternately, so that the object to be inspected 100 is illuminated by a single light pattern produced by a single light projector 30i. In this way, the cameras 10, 20 acquire successive images of the same object illuminated by (structured) light coming from different angles—without moving either the object 100 or the projectors 30i—and these images can be combined to have a complete and precise detection of the totality of the object.

Preferably, in the embodiments in which the light projectors 30i project structured light, thanks to the alternating activation of the projectors 30i themselves, a series of light patterns are projected onto the object 100, which can then be combined to perform a profilometry.

In preferred embodiments, the first 10 and the second 20 cameras are operatively connected to an electronic processing unit (not illustrated) configured to process and combine the acquired images of the two cameras 10, 20 so as to obtain a detection of the characteristics of the object.

This electronic processing unit may be comprised in, or consist of, the aforesaid electronic control unit, or it may be comprised in, or consist of, an external computing device, such as a computer or the like.

The operation of the apparatus for acquiring images for the inspection of an underlying object according to the invention is apparent from what is described and illustrated and, in particular, is substantially as follows.

The object 100 to be inspected is positioned in a station typically lower than the apparatus and suitably illuminated by the plurality of light projectors 30i and by the plurality of monochromatic or polychromatic light emitting rings 40i.

The light beam reflected by the object 100 through the dual objective optical group 55 is split into a first light beam directed along the first vertical optical arm 51 associated with the first camera 10 and coaxial with the vertical optical axis Z of the first camera 10, and a second light beam directed along the second horizontal optical arm 52 associated with the second camera 20 and coaxial with the horizontal optical axis X′ of the second camera 20.

Thanks to the particular structure of the optical system proposed in the present invention, the images acquired by the first camera and by the second camera are congruent and superimposable.

For an effective, immediate and repetitive inspection reading of the apparatus 1, the congruent images collected by the first camera 10 and by the second camera 20 must be appropriately superimposed and processed by processing systems of known, for example by the electronic processing unit in the manner described above.

An essential condition for a correct reading by the apparatus is that an alignment of the images acquired by the first camera 10 and by the second camera 20, and a congruence of at least two comers of the images acquired by the first sensor and the second sensor are ensured.

In the event that the horizontal optical arm 52 for reasons of construction and overall dimensions of the apparatus 1 is positioned with the first offset angle a relative to the axis X of the first sensor 110 of the first camera 10, typically coinciding with the angular position of at least one light projector 30i, the second sensor 120 of the second camera 20 has the axis Z′ rotated with a second offset angle β relative to a vertical axis parallel to the axis Z, uniquely determined by the value of the first offset angle α.

In practice, it has been found that the apparatus for acquiring three-dimensional information of objects and surfaces for an artificial vision system for automatic optical inspection of the visual quality of an underlying object according to the invention is particularly advantageous in that it is simple and effective, with compact dimensions and in that it does not present any interference among different components.

The apparatus for acquiring three-dimensional information of objects and surfaces for an artificial vision system for automatic optical inspection of the visual quality of an underlying object thus conceived is susceptible to many modifications and variants, all falling within the scope of the inventive concept as defined by the claims; furthermore, all the details are replaceable by technically equivalent elements.

For example, it is possible to provide special means for reconfiguring the images projected on the object.

In practice, the materials used, as well as the dimensions, can be any according to the needs and the state of the art.

1. An apparatus for acquiring three-dimensional information of objects and surfaces for an artificial vision system for automatic optical inspection of the visual quality of an underlying object, comprising a first camera having a vertical optical axis and a first flat sensor having orthogonal axes lying in a horizontal plane and a second camera having a horizontal optical axis and a second flat sensor having orthogonal axes lying in a vertical plane, a system for illuminating the object from above comprising a plurality of light projectors, a dual objective optical group having a first vertical optical arm associated with said first camera and coaxial with said vertical optical axis and a second horizontal optical arm associated with said second camera and coaxial with said horizontal optical axis, an optical beam splitter configured to split the light beam reflected by said object into a first light beam directed along said first optical arm and a second light beam directed along said second optical arm, wherein the light projectors are angularly spaced around the vertical optical axis of said first camera, and wherein said first and second flat sensor have the same shape and are arranged to acquire said object with the same field of view.

2. The apparatus according to claim 1, wherein said optical group is telecentric or bi-telecentric.

3. The apparatus according to claim 1, wherein one of said first camera and said second camera is a high-resolution camera.

4. The apparatus according to claim 1, wherein one of said first camera and said second camera is a camera capable of acquiring images containing information related to the polarisation of the light incident on the sensor.

5. The apparatus according to claim 1, wherein at least one light projector is set, relative to said vertical optical axis of said first camera, in an angular position coinciding with that of said axis of said first sensor of said first camera.

6. The apparatus according to claim 1, further comprising a plurality of monochromatic or polychromatic light emitting rings, coaxial with said vertical optical axis of said first camera having an increasing diameter and increasing distance away from said first camera.

7. The apparatus according to claim 1, wherein said plurality of light projectors comprises at least four light projectors angularly evenly spaced around said vertical optical axis of said first camera.

8. The apparatus according to claim 1, wherein said plurality of light projectors have a vertical projection axis parallel to said vertical optical axis of said first camera.

9. The apparatus according to claim 1, comprises further comprising a plurality of mirrored reflectors reciprocally interposed between said plurality of projectors and the station for the object for the conversion of the plurality of optical paths of the light from said plurality of projectors to said object.

10. The apparatus according to claim 1, wherein said plurality of light projectors have inclined projection axes arranged to converge on the station for said object.

11. The apparatus according to claim 1, wherein each light projector of the plurality of light projectors comprises at least one LED light source, at least one lens, an optical beam splitter and a digital micromirror display (DMD), wherein the lens can be positioned between the LED light source and the optical beam splitter, and the optical beam splitter can be positioned between the lens and the digital micromirror display (DMD) and at least one further lens can be positioned between said digital micromirror device and said object to be illuminated.

12. The apparatus according to claim 11, wherein at least one light projector of the plurality of light projectors comprises at least three different monochromatic LED light sources, each associated with a corresponding lens, and an optical system interposed between said lenses and said optical beam splitter and configured to collimate the light beams emitted by said three LED light sources.

13. The apparatus according to claim 1, further comprising a means for reconfiguring the images projected onto the object.

14. The apparatus according to claim 1, wherein said first and second flat sensors are two-dimensional pixel sensors.
